(19) United States
(12) Patent Application Publication
(10) Pub. No.: US 2012/0091966 A1
(43) Pub. Date: Apr. 19, 2012

(54) CHARGING CONTROL METHOD AND BATTERY PACK FOR SECONDARY BATTERY

(75) Inventor: Yasushi MORI, Fukushima (JP)

(73) Assignee: SONY CORPORATION, Tokyo (JP)

(21) Appl. No.: 13/248,202

(22) Filed: Sep. 29, 2011

(30) Foreign Application Priority Data
Oct. 14, 2010 (JP) 2010-231456

(51) Int. Cl. H02J 7/00

(52) U.S. Cl. 320/134; 320/162; 320/160

(57) ABSTRACT

A charge control method of secondary batteries including measuring a charge current value when charging ends with regard to an assembled battery where a plurality of secondary batteries are connected in series, in parallel, or in series-parallel, storing the charge current value, and performing charging of the secondary batteries at the stored charge current value when starting the next charging with regard to the secondary batteries.

### CROSS REFERENCES TO RELATED APPLICATIONS

The present application claims priority to Japanese Priority Patent Application JP 2010-231456 filed in the Japan Patent Office on Oct. 14, 2010, the entire contents of which are hereby incorporated by reference.

### BACKGROUND

The present application relates to a charging control method and a battery pack for a secondary battery, and in particular to a charging control method and a battery pack for a secondary battery where it is possible to safely charge each of a plurality of battery cells which have different states of deterioration.

In recent years, in portable electronic devices such as personal laptop computers, mobiles phones, and PDAs (Personal Digital Assistants) and in high-output devices such as devices onboard cars or electric tools, battery packs which use secondary batteries are in wide spread use as a power source. Among secondary batteries, lithium ion secondary batteries are widely used in battery packs since lithium ion secondary batteries have the advantages of being light weight, high capacity, easy to detect remaining capacity, and having a long life cycle.

The battery pack is a disposable consumption good and the secondary batteries contained inside thereof deteriorate as the number of times of use increases or after being left for a long time. The secondary batteries which have deteriorated have high impedance and voltage rises sharply when an current for charging flows therein and a prohibited charge voltage may be reached.

In order to avoid a problem such as this, as in Japanese Unexamined Patent Application Publication Nos. 2008-220110, 9-298845, 9-84277, and 2006-81334, there is a method where the full charge voltage of a secondary battery and the voltage of a secondary battery are compared and the charging current is controlled.

For example, in Japanese Unexamined Patent Application Publication No. 2008-220110, in a case where the largest cell voltage, out of cell voltages which are measured from each of a plurality of battery cells, and a full charge voltage are compared and the largest cell voltage is larger than the full charge voltage, a charge current designated by a charge voltage designation value is reduced. In addition, in a case where the largest cell voltage and the full charge voltage are compared and the largest cell voltage is smaller than the full charge voltage, the charge current designated by the charge voltage designation value is increased. By using a charge method in which a control, where the charge voltage designation value such as this is changed, is performed periodically during charging, charging of the battery cells where there is deterioration until an excess charge region is prevented.

In Japanese Unexamined Patent Application Publication No. 9-298845, a charge method is disclosed where, first, an initial charge is performed at a current with a size of approximately 0.1 CmA, and if a terminal voltage rises up to a prescribed voltage, then, rapid charging is performed at a current with a size of, for example, 1.0 CmA.

In Japanese Unexamined Patent Application Publication No. 9-84277, a charge control method is disclosed where deterioration of a battery is suppressed by determining a maximum permissible charge current value Ir which is more thermal than an internal resistance value of the battery and by the internal resistance value being increased and a charge current value being decreased so as not to exceed the maximum permissible charge current value Ir.

In Japanese Unexamined Patent Application Publication No. 2006-81334, a charge and discharge control method is disclosed where an internal resistance value of a cell with the largest variation in voltage is calculated, a voltage of a cell with the largest variation in voltage is calculated, and based on the calculated voltage value, at least one of a largest charge amount and a largest discharge amount of an assembled battery is controlled. In the charge and discharge control method of Japanese Unexamined Patent Application Publication No. 2006-81334, it is possible to determine largest charge and discharge amounts according to variation in voltage using a simple configuration where it is not necessary to have a configuration in which the voltage of each cell is detected.

### SUMMARY

However, in the charge method of Japanese Unexamined Patent Application Publication No. 2008-220110, as shown in FIG. 1, charging starts at a largest charge current value when starting charging and charge current adjustment control is periodically performed according to the comparison between the cell voltage and the full charge voltage. As a result, there are cases where the cell voltage exceeds a prohibited charge voltage until the next period when the largest cell voltage and the full charge voltage are compared. If the prohibited charge voltage is reached, there is a problem in that charging stops due to the working of prohibited charge protection, an abnormality is detected and an alarm is generated, and a user is notified that the abnormality has been generated in the pack, and there are cases where there is a defect which stops charging. In addition, it is not possible to draw out the life of a battery to the maximum extent since, even in a slightly unbalanced deterioration state of initial deterioration, the cell voltage reaches the prohibited charge voltage and the charging is stopped when the charge current value is large.

In addition, in the charge method of Japanese Unexamined Patent Application Publication No. 9-298845, in a case where the internal resistance of the battery becomes large since there is a sudden switch from the current of approximately 0.1 CmA to the current of approximately 1.0 CmA, there is a problem in that the cell voltage exceeds the prohibited charge voltage immediately after the switching of the charge currents.

In the charge control method of Japanese Unexamined Patent Application Publication No. 9-84277, it is possible to prevent the temperature from rising in a deteriorated cell but a control is not performed for preventing the deteriorated cell from reaching the prohibited charge voltage. As a result, in a case where voltage balance between battery cells has broken down, there is a problem where the largest cell voltage exceeds the prohibited charge voltage due to the value of the maximum permissible charge current value Ir.

Furthermore, in the charge and discharge control method of Japanese Unexamined Patent Application Publication No. 2006-81334, performing of control from the determined internal resistance value is with regard to the charge amount and not the charge current amount. Accordingly, it is possible to prevent excessive charging of the battery cell (open circuit voltage OCV exceeding the prohibited charge voltage), but it is not possible to prevent the cell voltage (closed circuit voltage CCV) reaching the prohibited charge voltage. In addition, in the charge and discharge control method of Japanese Unexamined Patent Application Publication No. 2006-81334, a capacitance adjustment circuit is provided, and by discharging via a bypass circuit in a case where the cell voltage exceeds the prohibited charge voltage, the closed circuit voltage CCV is prevented from exceeding the prohibited charge voltage during charging. As a result, since it is necessary for a capacitance adjustment circuit to be provided for each cell, there is a problem of rising costs.

It is desirable that a battery pack is provided where it is possible to perform charging without the cell voltage exceeding the prohibited charge voltage when starting charging even in a case where a voltage balance of each of a plurality of battery cells in the battery pack is in an unbalanced state.

A charge control method according to an embodiment includes measuring a charge current value when charging ends with regard to an assembled battery where a plurality of secondary batteries are connected in series, in parallel, or in series-parallel, storing the charge current value, and performing charging of the secondary batteries at the stored charge current value when starting the next charging with regard to the secondary batteries.

In addition, a battery pack according to an embodiment is provided with an assembled battery where a plurality of secondary batteries are connected in series, in parallel, or in series-parallel, a switch element which controls charging and discharging of the secondary batteries, a measurement section which measures a battery voltage of each of the plurality of secondary batteries and measures a charge current value of the secondary batteries, a calculation section which detects a largest cell voltage which is the largest battery voltage out of the measured battery voltages of the plurality of secondary batteries and sets the charge current value which is stored in a storage unit as the charge current when starting charging when starting the next charging with regard to the secondary batteries, a switch element control section which controls the switch element based on the measured battery voltage of the plurality of secondary batteries, a storage unit which stores a full charge voltage and the charge current value when charging ends, and a communication section which is able to perform communication with a connected electronic apparatus and send the charge voltage value which is set by the calculation section, where the charge current which is designated by the charge current value is supplied to the secondary battery.

Furthermore, a battery pack according to an embodiment is provided with an assembled battery where a plurality of secondary batteries are connected in series, in parallel, or in series-parallel, a switch element which controls charging and discharging of the secondary batteries, a measurement section which measures a battery voltage of each of the plurality of secondary batteries and measures a charge current value of the secondary batteries, a calculation section which detects a largest cell voltage which is the largest battery voltage out of the measured battery voltages of the plurality of secondary batteries and sets the charge current value which is stored in a storage unit as the charge current when starting charging when starting the next charging with regard to the secondary batteries, a switch element control section which controls the switch element based on the measured battery voltage of the plurality of secondary batteries, a storage unit which stores a full charge voltage and the charge current value when charging ends, and a charge supply section which has a variable current source and a variable voltage source where it is possible for a charge current which is designated by the charge current value set by the calculation section and a predetermined charge voltage to be generated and supplied to the secondary batteries.

In the embodiments, since, when starting the next charging with regard to the secondary batteries, charging is performed at the stored charge current value when the previous charging ended, the voltage of the secondary batteries does not reach to the prohibited charge voltage immediately after the charging starts.

According to the embodiments, since the battery voltage does not exceed the prohibited charge voltage immediately after charging starts even in a case where a voltage balance of each of a plurality of battery cells in the battery pack is in an unbalanced state, it is possible to perform charging which is safe and where battery life is lengthened.

Additional features and advantages are described herein, and will be apparent from the following Detailed Description and the figures.

### BRIEF DESCRIPTION OF THE FIGURES

FIG. 1 is a graph illustrating voltage and current during charging of a secondary battery in a case where a charge control method in the related art is used;

FIG. 2 is a block diagram illustrating a charge and discharge system according to a first embodiment;

FIG. 3 is a block diagram illustrating an example of a configuration of the battery pack of FIG. 2 in more detail;

FIG. 4 is a flow chart illustrating a charge operation according to the first embodiment;

FIG. 5 is a cross-sectional diagram illustrating a cross-sectional configuration of a battery cell according to the first embodiment;

FIG. 6 is a cross-sectional diagram illustrating a cross-sectional configuration of a rolled electrode which accommodates a battery cell according to the first embodiment;

FIG. 7 is an exploded diagram and an exploded perspective diagram illustrating one configuration example of a battery pack;

FIG. 8 is a block diagram illustrating a charge system according to a second embodiment;

FIG. 9 is a flow chart illustrating a charge operation of a charge control method according to the second embodiment;

FIG. 10 is a flow chart illustrating a charge operation of a charge control method according to a third embodiment; and

FIG. 11 is a graph illustrating a voltage value (solid line) and a current value (dotted line) of a battery cell in a case where the charge control method of FIG. 10 is used.

### DETAILED DESCRIPTION

Embodiments of the present application will be described below in detail with reference to the drawings.

1. First Embodiment (First Example of Circuit Configuration and Charge Control Method)

2. Second Embodiment (Second Example of Circuit Configuration)

3. Third Embodiment (Second Example of Charge Control Method)

4. Fourth Embodiment (Third Example of Charge Control Method)

### 1. First Embodiment

In the first embodiment, a configuration is shown where a battery cell of a battery pack is charged on the basis of the control of a charge supply section which is built into an electronic apparatus.

(1-1) First Circuit Configuration

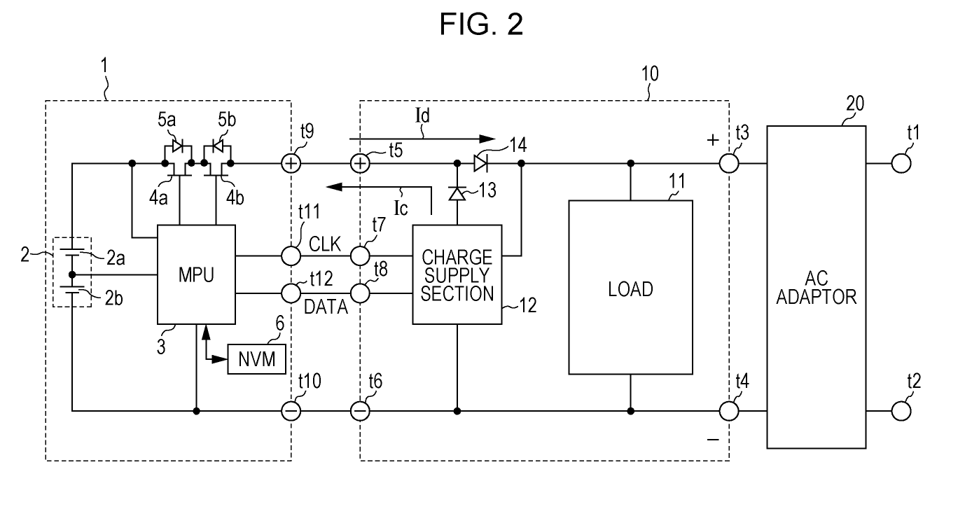

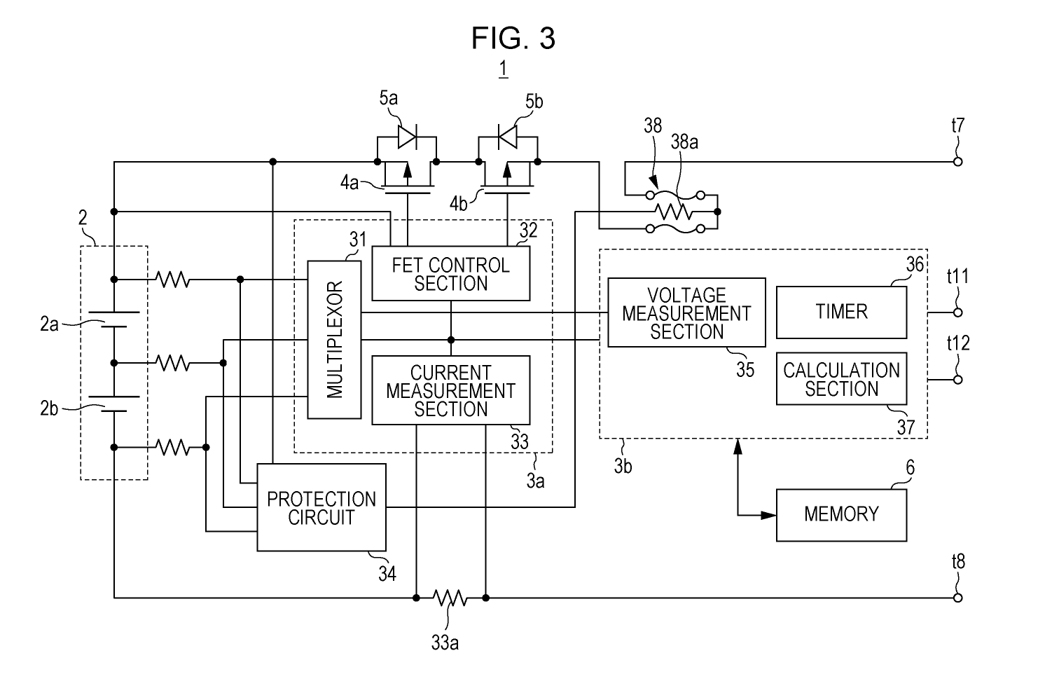

First, a circuit configuration according to the first embodiment will be described with reference to diagrams. FIG. 2 is a block diagram illustrating a charge and discharge system according to the first embodiment. In addition, FIG. 3 is a block diagram illustrating an example of a configuration of the battery pack of FIG. 2 in more detail.

The charge system according to the first embodiment is configured using a battery pack 1, an electronic apparatus (for example, a portable personal computer) 10, and an AC adapter 20. Input terminals t1 and t2 of the AC adapter 20 are connected to a commercial power supply and there is a predetermined DC voltage which is generated from the commercial power supply at output terminal t3 and t4 of the AC adapter 20.

The DC voltage which is output from the AC adapter 20 when the commercial power supply and the AC adapter 20 are connected is supplied with regard to a load 11 of the electronic apparatus 10 and a charge supply section 12. The load 11 is a circuit or the like which the electronic apparatus 10 has. The charge supply section 12 performs communication with the battery pack 1. By receiving a control signal from the battery pack 1 and controlling a processor (MPU (Micro Processing Unit)) in the charge supply section 12, the charge supply section 12 has a variable current source and a variable voltage source where it is possible for a desired charge current and charge voltage which are sent from a MPU 3 in the battery pack 1 to be generated. The largest value of the charge voltage is smaller than the DC voltage which is supplied from the AC adapter 20. Terminals t5 and t6 of the electronic apparatus 10 are respectively connected to terminals t9 and t10 of the battery pack 1. A charge current Ic is supplied from the charge supply section 12 to the battery pack 1 via a reverse current prevention diode 13 and the terminals t5 and t6.

The battery pack 1 has an assembled battery 2 where battery cells 2a and 2b of, for example, a lithium ion secondary battery are connected in series, the MPU 3, a charge control FET (Field Effect Transistor) 4a, a discharge control FET 4b, and a nonvolatile memory (NVM) 6. Here, the configuration where the battery cells 2a and 2b are connected in series is only one example, and a plurality of battery cells may be connected in parallel or connected in series-parallel, where, for example, a unit of a plurality of battery cells which are connected in parallel are further connected in series.

As the nonvolatile memory 6, for example, an EEPROM (Electrically Erasable and Programmable Read Only Memory) is used. In the nonvolatile memory 6, other than information such as an initial full charge capacity and a full charge capacity which considers and corrects for the level of deterioration of the battery cells 2a and 2b (referred to below as a corrected full charge capacity), the charge current value when the charging process ends is stored.

In a case of using, for example, lithium ion secondary batteries where the full charge voltage for each individual cell is 4.2 V, the constant-voltage charge voltage of the battery pack 1 of the first embodiment is 8.4 V. Between the source and the drain of the charge control FET 4a and the discharge control FET 4b, there respectively are parasitic diodes 5a and 5b. The parasitic diode 5b has a polarity which is in a forward direction with regard to the charge current Ic and a reverse direction with regard to a discharge current Id. The parasitic diode 5a has a polarity which is in a reverse direction with regard to the charge current Ic and a forward direction with regard to the discharge current Id.

A control signal from a FET control section 32 of the MPU 3 are supplied to each of the gates of the charge control FET 4a and the discharge control FET 4b. The charge control FET 4a and the discharge control FET 4b are, for example, P channel types, and thus, are in an ON state due to a gate potential being lower than a source potential by a predetermined value or more.

During charging, the charge control FET 4a and the discharge control FET 4b are made to be in an ON state and the charge current Ic which is output from the charge supply section 12 is supplied to the battery cells 2a and 2b via the reverse current prevention diode 13 and the charge control FET 4a and the discharge control FET 4b. In a state where power is not supplied to the electronic apparatus 10 by the AC adaptor 20, the discharge current Id is supplied from the battery cells 2a and 2b via the charge control FET 4a, the discharge control FET 4b, and a reverse current prevention diode 14 to the load 11.

Here, according to the configuration of the battery pack 1, an N channel type FET may be used as the charge control FET 4a and the discharge control FET 4b. In a case where an N channel type FET is used, the charge control FET 4a and the discharge control FET 4b are in an ON state due to a gate potential being higher than a source potential by a predetermined value or more.

A clock transmission path CLK and a data transmission path DATA are configured by a clock terminal t11 and a data terminal t12 of the MPU 3 of the battery pack 1 being connected to a clock terminal t7 and a data terminal t8 of the processor in the charge supply section 12 of the electronic apparatus 10.

As shown in FIG. 3, in the MPU 3 of the battery pack 1, for example, an AFE (Analog Front-End) 3a measures the voltage of the assembled battery 2 and each of the battery cells 2a and 2b which configure the assembled battery 2, the measured voltage is A/D converted, and supplied to a CPU (Central Processing Unit) 3b. The AFE 3a measures the current using a current detection resistor 7 and supplies the measured voltage to the CPU 3b.

The MPU 3 of the battery pack 1 has a function of measuring the battery cell voltages of each of the battery cells 2a and 2b and the voltage of the entire assembled battery, a function of measuring charge and discharge current values, a function of controlling the charge control FET 4a and the discharge control FET 4b, a function of setting an optimal charge current value when recharging from the charge current value when the previous charging process ended which is stored in the nonvolatile memory 6, and a function of sending the calculated optimal charge current value and information which is stored in the nonvolatile memory 6 to the processor in the charge supply section 12 via the clock transmission path and the data transmission path.

As shown in FIG. 3, it is possible for a multiplexer 31 to select which of the voltages out of that of the batteries cells 2a and 2b or the assembled battery 2 is to be measured, and the voltage of the selected portion is A/D converted and detected by a voltage measurement section 35. It is possible for the charge and discharge current values to be detected by a current measurement section 33 using a current measurement resistor 33a. The control of the charge control FET 4a and the discharge control FET 4b is performed using the control signal output from the FET control section 32. The setting of the optimal charge current value when recharging is performed using a calculation section 37. In addition, the voltage value and the current value are measured once every constant interval such as once a second and the constant measurement intervals is counted by, for example, a timer 36.

A fuse 38 is connected in series with the secondary batteries 2a and 2b and, when an excessive current flows in the secondary batteries 2a and 2b, melts due to its own current and stop the current. In FIG. 3, a configuration is shown where a heater resistance 38a is provided in the vicinity of the fuse 38, the fuse 38 is melted by the temperature of the heater resistance 38a increasing when there is excessive voltage and the current is stopped.

A protection circuit 34 measures the voltage of the assembled battery 2 and the battery cells 2a and 2b which configure the assembled battery 2 and melts the fuse 38 in a case where the measured voltages exceed a predetermined voltage. In the configuration of FIG. 3, the protection circuit 34 melts the fuse 38 by applying a voltage to the heater resistance 38a when there is an excessive voltage and increasing the temperature. The protection circuit 34 performs melting of the fuse 38 without receiving control from the MPU 3. As a result, in a case where there is a problem with the MPU 3 and control of the charge control FET 4a is not able to be performed if the voltage is a predetermined amount or more, it is possible to stop the current.

Here, a temperature element such as a thermistor may be provided in the battery pack 1 and the temperature of the battery cells 2a and 2b, the assembled battery 2 and the battery pack 1 may be detected using the MPU 3. When detecting the temperature of the battery cells 2a and 2b and the assembled battery 2, by sending the detected temperature to the electronic apparatus 10, charge control and deterioration detection may be performed according to battery temperature. In addition, when the temperature rises, a current limiting element such as a positive temperature coefficient element (PTC element) which limits the current when a resistance value increases may be connected in series with the battery cells 2a and 2b. Furthermore, one of both of the charge control FET 4a and the discharge control FET 4b of the battery pack 1 may be inserted in the electronic apparatus 10.

The MPU 3 supplies the control signal with regard to each of the gates of the charge control FET 4a and the discharge control FET 4b, and performs a protection operation by controlling ON/OFF of the charge control FET 4a and the discharge control FET 4b. As the protection operation, there is an excessive charge and an excessive discharge protection function. Below, the protection functions will be simply described.

First, the excessive charge protection function will be described. When charging the battery cells 2a and 2b, the battery voltage continues to increase even if in excess of the full charge. There is a possibility of a hazardous state if there is an excess charge state. Accordingly, it is necessary that the charging is performed at a constant voltage and a constant charge and so that the largest charge voltage is equal to or less than a battery rated full charge voltage (for example, 4.2 V in the case of a single battery cell). However, there is a danger of excess charging due to a fault in the charger, use of irregular parts in the charger, or the like. When there is excess charging and a prohibited charge voltage (for example, 4.3 V) is detected where the battery voltage exceeds the full charge voltage value, the charge control FET 4a is turned OFF by an output signal of the MPU 3 and the charge current is stopped. This function is the excessive charge protection function. When the charge control FET 4a is turned OFF, only discharging is possible via the discharge control FET 4b and the parasitic diode 5a. Here, in a case of a lithium ion secondary battery, the excess charge detection voltage is set as, for example, 4.225±0.025 [V].

The excessive discharge protection function will be described. In a case where there is discharge until a rated discharge termination voltage or less and the battery voltage is in an excess discharge state of, for example, 2 V to 1.5 V or less (in the case of a single battery cell), a fault may occur in the battery. In a case where there is discharge and the battery voltage is a certain voltage value or less, the discharge control FET 4b is turned OFF by an output signal of the MPU 3 and the discharge current is stopped. This function is the excessive discharge protection function. When the discharge control FET 4b is turned OFF, only charging is possible via the charge control FET 4a and the parasitic diode 5b. Here, in a case of a lithium ion secondary battery, the excess discharge detection voltage is set as, for example, 2.5±0.1 [V].

(1-2) First Charge Control Method

In the first embodiment, in addition to the normal charge and discharge operation and the excessive charge and discharge protection operations described above, charge control is performed so that the cell voltage does not exceed the prohibited charge voltage when starting charging. Due to the performing of the charge control which is described below, it is possible to perform charging without the cell voltage exceeding the prohibited charge voltage when starting charging even in a case where the plurality of battery cells in the battery pack have deteriorated and a voltage balance of each of the battery cells is in an unbalanced state.

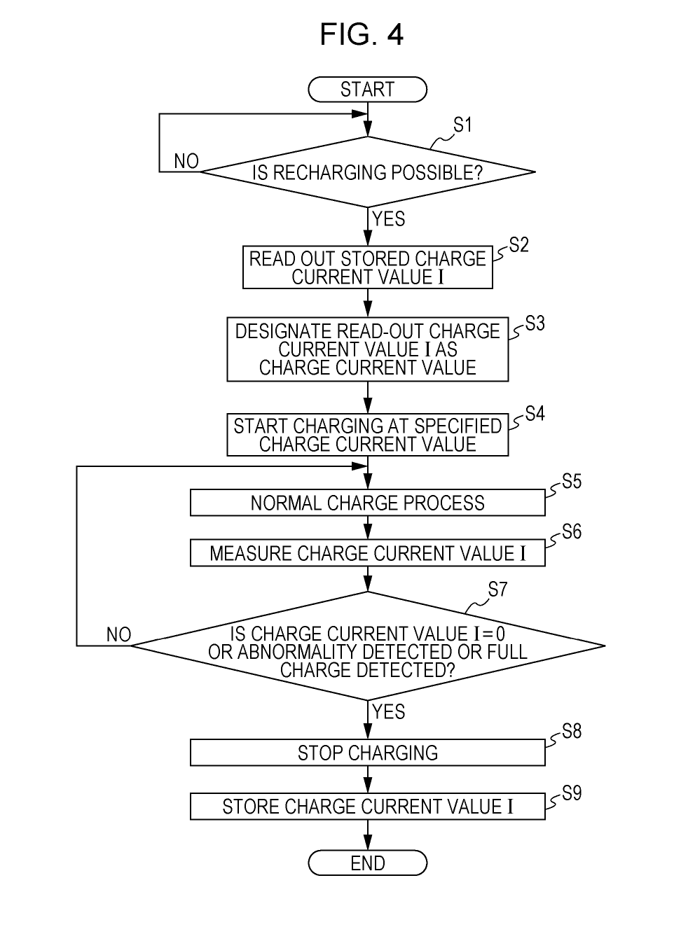

FIG. 4 is a flow chart illustrating a charge operation according to the first embodiment. Here, the process below is performed by the MPU 3 of the battery pack 1 or by the control signal being sent to the electronic apparatus 10 from the MPU 3.

When starting the charge operation, in step S1, it is confirmed whether recharging of the battery cells 2a and 2b is possible. A state where recharging is possible is at an appropriate cell voltage and not, for example, when the cell is in an excess charge state or excess discharge state, a case where the cell voltage has decreased from a full charge state and recharging has become necessary, a case where an abnormal state has been cancelled when in an abnormality detection state, a case where the charge current is detected, or the like. In a case where it is not determined in step S1 that recharging is possible, step S1 is repeated once every constant interval.

In a case where it is determined in step S1 that recharging is possible, the process moves to step S2. In step S2, the MPU 3 reads out a charge current value I which is stored in the nonvolatile memory 6. Here, in the embodiment, the current charge value when the charge operation ends is stored in the nonvolatile memory 6 when the previous charge operation ends. In addition, when shipping the battery pack 1, it is preferable if an appropriate charge current value when starting an initial charge or a charge current value when preparation of charging ends is stored in the nonvolatile memory 6.

Next, the charge current value I when the previous charge operation ended which is read out from the nonvolatile memory 6 in step S3 is designated as the charge current value when the next charging starts. The designated charge current value is sent from the MPU 3 to the electronic apparatus 10. Next, in step S4, in a case where the charge control FET 4a is OFF, the charge control FET 4a is turned ON and the charging of the battery cells 2a and 2b starts at the designated charge current value. The battery cells 2a and 2b are charged by the charge supply section 12 of the electronic apparatus 10 generating the designation value of the charge current and the charge voltage.

When charging is started in step S4, a normal charging process is performed in step S5. In the normal charge process in step S5, charging with a constant current and a constant voltage is performed until a predetermined full charge voltage is reached while excess charge protection and excess discharge protection described above, and the like are performed. In addition, in a case where the cell voltage is equal to or more than the prohibited charge voltage, control is performed so that charging and discharging are permanently prohibited.

Next, in step S6, the charge current value I is measured. The charge current value I is measured once every predetermined constant interval. Then, in a case where it is determined in step S7 that the charge current value I is equal to zero, an abnormality is detected, or there is the full charge state, the process moves to step S8, and the charging is stopped by the discharging control FET 4b being turned OFF. In a case where it is not determined in step S7 that the charge current value I is equal to zero, an abnormality is detected, or there is the full charge state, the process returns to step S5 and the normal charge process is continued. In a case where the charging is stopped in step S8, the process moves to step S9 and the charge current value I which was measured last is stored in the nonvolatile memory 6. According to this, the charging process ends.

(1-3) Configuration of Battery Cell

Next, the battery cells 2a and 2b which are accommodated in the battery pack 1 will be described. Here, since the battery cells 2a and 2b have the same configuration, description of the battery cell 2a is performed below.

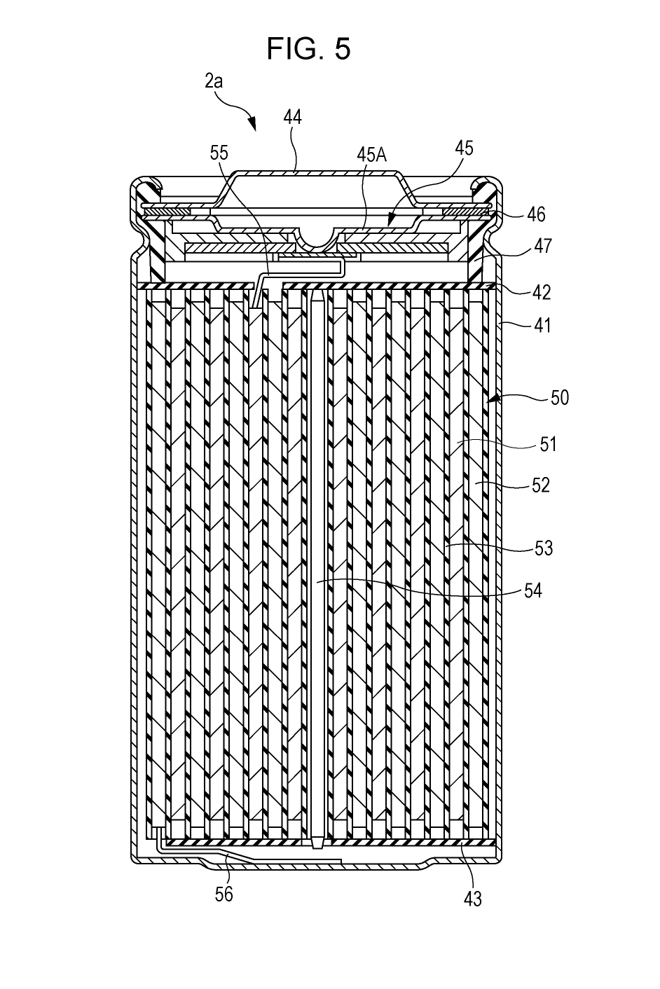

FIG. 5 is a cross-sectional diagram illustrating a cross-sectional configuration of the battery cell 2a according to the first embodiment. The battery is, for example, a lithium ion secondary battery. The battery cell 2a has the same configuration as the battery cell 2b and is accommodated in the battery pack 1, for example, as shown in FIGS. 2 and 3.

As shown in FIG. 5, the battery cell has a so-called cylindrical shape and has a rolled electrode 40 where a positive electrode 51 with a strip shape and a negative electrode 52 with a strip shape are rolled up with a separator 53 in an inner portion of a battery can 41 with a substantially hollow cylindrical shape. The battery can 41 is configuration by, for example, iron (Fe) being plated with nickel (Ni), and one end portion is closed while the other end portion is open. At an inner portion of the battery can 41, each of a pair of insulating plates 42 and 43 are disposed perpendicularly with regard to the rolled circumference surface so as to interpose the rolled electrode 40.

In the open end portion of the battery can 41, a battery cap 44, a safety valve mechanism 45 provided at an inner side of the battery cap 44, and a positive temperature coefficient element 46 are attached by caulking via a gasket 47 and the inner portion of the battery can 41 is tightly sealed. The battery cap 44 is configured by, for example, the same material as the battery can 41.

The safety valve mechanism 45 is electrically connected to the battery cap 44 via the positive temperature coefficient element 46, and in a case where the internal pressure of the battery is equal to or more than a constant due to an internal short-circuit, heat from outside, or the like, a disk plate 45A is reversed and the electrical connection between the battery cap 44 and the rolled electrode 40 is cut off. The positive temperature coefficient element 46 limits the current by increasing resistance when the temperature rises and prevents abnormal heat generation due to a large current. The gasket 47 is configured by, for example, an insulating material and asphalt is coated on a surface.

The rolled electrode 40 is rolled around centered, for example, on a center pin 54. A positive lead 55 which is formed from aluminum (Al) or the like is connected to the positive electrode 51 of the rolled electrode 40 and a negative lead 56 which is formed from nickel (Ni) or the like is connected to the negative electrode 52. The positive lead 55 is electrically connected to the battery cap 44 due to welding of the safety valve mechanism 45 and the negative lead 56 is welded to and electrically connected with the battery cap 41.

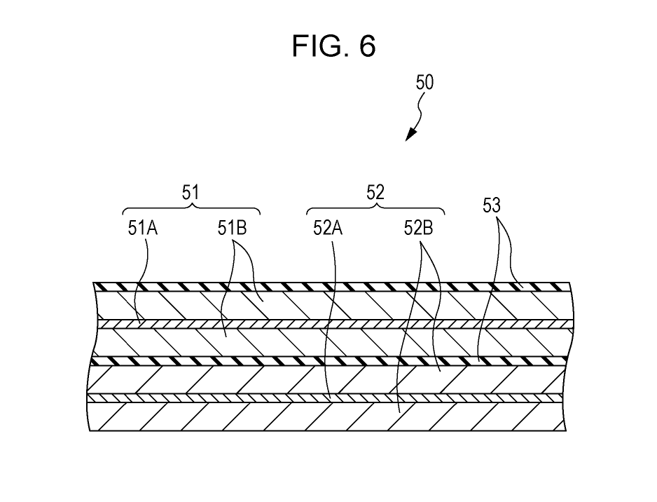

FIG. 6 represents an enlargement of a portion of the rolled electrode 40 shown in FIG. 5.

Positive Electrode

The positive electrode 51 has, for example, a positive electrode collector 51A and positive electrode active-material layers 51B which are provided on both surfaces of the positive electrode collector 51A. Here, only one surface of the positive electrode collector 51A may have a region where there is the positive electrode active-material layer 51B. The positive electrode collector 51A is configured by, for example, a metallic foil such as aluminum (Al) foil.

The positive electrode active-material layer 51B, for example, includes a positive electrode active material, a dielectric material such as carbon in fiber form or carbon black, and a binding agent such as polyvinylidene fluoride (PVdF). As the positive electrode active material, there is the positive electrode active material which includes one type or two or more types of any positive electrode material which is able to absorb or release lithium which is a positive electrode reactant and where the reaction potential thereof with regard to lithium is, for example, 3 V to 4.5 V. As a positive electrode material such as this, there are, for example, complex oxides which include lithium. Specifically, as a complex oxide of lithium and a transition metal, it is possible to use lithium cobalt oxide (LiCoO₂) or lithium nickel oxide (LiNiO₂) which have layered structures, or a solid solution which includes the oxides (LiNiₓCo_{y}Mn_{z}O₂; in the formula, the values of x, y and z are such that 0<x<1, 0<y<1, 0<z<1, and x+y+z=1).

Then, as the positive electrode material, it is also possible to use lithium manganese oxide (LiMn₂O₄) with a spinel structure, a solid solution thereof (Li(Mn₂₋ᵥNiᵥ)O₄; in the formula, the value of v is such that v<2), or the like. Furthermore, as the positive electrode material, it is also possible to use, for example, a phosphate compound such as lithium iron phosphate (LiFePO₄) with an olivine structure. This is because it is possible to obtain high energy density. Here, other than the materials described above, the positive electrode material may be, for example, an oxide such as titanium oxide, vanadium oxide, or manganese oxide, a disulfide such as iron disulfide, titanium disulfide, or molybdenum sulfide, sulfur, or a conductive polymer such as polyaniline or polythiophene.

As the dielectric material, there is no particular limitation as long as it is possible to mix an appropriate amount with the positive electrode active material and conductivity is imparted. However, a carbon material such as carbon black or graphite or the like is used. As the binding agent, it is possible to use an existing binding agent which is normally used as a positive electrode binder for this type of batteries. However, it is preferable if a fluorocarbon resin such as polyvinyl fluoride (PVF), polyvinylidene fluoride (PVdF), or polytetrafluoroethylene (PTFE).

Negative Electrode

The negative electrode 52 has, for example, a negative electrode collector 52A and negative electrode active-material layers 52B which are provided on both surfaces of the negative electrode collector 52A. Here, only one surface of the negative electrode collector 52A may have a region where there is the negative electrode active-material layer 52B. The negative electrode collector 52A is configured by, for example, a metallic foil such as copper (Cu) foil.

The negative electrode active-material layer 52B includes, for example, a negative electrode active material, and if necessary, a dielectric material, a binding agent, or other materials which do not contribute to charging such as a viscosity modifier may be included. As the dielectric material, there are graphite fibers, metallic fibers, metallic powder, or the like. As the binding agent, there are fluorocarbon polymer compounds such as polyvinylidene fluoride (PVdF), synthetic rubbers such as styrene-butadiene rubber (SBR) or ethylene propylene diene rubber (EPDR), or the like.

As the negative electrode active material, there is a configuration including one type or two or more types of any negative electrode material which is able to electrochemically absorb or release lithium (Li) at a potential of 2.0 V or less with regard to lithium metal.

As the negative electrode material which is able to absorb or release lithium (Li), for example, there are carbon materials, metallic compounds, oxides, sulfates, lithium nitrides such as LiN₃, lithium metal, metals which forms an alloy with lithium, polymer material, or the like.

As the carbon material, for example, there is non-graphitizable carbon, graphitizable carbon, graphite, pyrolytic carbons, cokes, glassy carbons, organic polymer compound fired substances, carbon fibers, or activated carbon. Out of the carbon material, as the cokes, there are pitch coke, needle coke, petroleum coke, and the like. The organic polymer compound fired substances refer to polymer materials such as phenol resin or furan resin which is fired at an appropriate temperature and carbonized, and portions thereof are classified as non-graphitizable carbon or graphitizable carbon. In addition, as the polymer material, there are polyacetylene, polypyrrole, and the like.

Among the negative electrode materials which are able to absorb or release lithium (Li), it is preferable that the charge and discharge potential is relatively close to that of lithium metal. This is because high energy density is easier as the charge and discharge potential of the negative electrode 52 is lower. Among the negative electrode materials, the carbon materials are preferable as it is possible to obtain a high charge and discharge capacitance with extremely few changes in the crystal structure generated when charging and discharging and it is possible to obtain excellent cycling characteristics. In particular, graphite is preferable as it is possible to obtain high energy density with a large electrochemical equivalent. In addition, non-graphitizable carbon is preferable as it is possible to obtain superior cycling characteristics.

As the negative electrode materials which are able to absorb or release lithium (Li), in addition, there are lithium metal just itself, a metal element or a metalloid element which is able to form an alloy with lithium (Li) and which is used by itself, in an alloy, or as a compound. These negative electrode materials are preferable as it is possible to obtain high energy density, and in particular, are preferable if used with a carbon material as it is possible to obtain high energy density and it is possible to obtain superior cycling characteristics. Here, in the embodiment, as the alloys, in addition to alloys formed from two or more types of metal elements, there are also alloys formed from one or more types of metal element and one or more type of metalloid element. In this organization, there are solid solutions, eutectics (eutectic mixtures), intermetallic compounds, or combinations of two or more types thereof.

As the metal elements or metalloid elements, for example, there are tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). As the alloys or compounds, for example, there are alloys and compounds expressed by the chemical formula of Ma_{f}Mb_{g}Liₕ and the chemical formula MaₛMcₜMdᵤ. In the chemical formula, Ma represents at least one type of metal element or metalloid element which is able to form an alloy with lithium, Mb represents at least one type of metal element or metalloid element other than lithium or Ma, Mc represents at least one type of non-metal element, and Md represents at least one type of metal element or metalloid element other than Ma. In addition, the values of f, g, h, s, t, and u are such that f>0, g≧0, h≧0, s>0, t>0, and u≧0.

Among the metal elements or metalloid elements, Group IVB (in regard to a short-form periodic chart) of a metal element or a metalloid element by itself, as an alloy, or as a compound is preferable, and in particular, silicon (Si), tin (Sn), or an alloy or compound thereof is preferable. The metal element or metalloid element may be a crystalline substance or an amorphous substance.

As the negative electrode materials which are able to absorb or release lithium, furthermore, there are other metallic compounds such as oxides, sulfates, lithium nitrides such as LiN₃, or the like. As the oxides, there are MnO₂, V₂O₅, V₆O₁₃, and the like. In addition, as oxides which are able to absorb or release lithium at a low relative potential, for example, there are iron oxides, ruthenium oxides, molybdenum oxides, tungsten oxides, titanium oxides, tin oxides, and the like. As the sulfates, there are NiS, MOS, and the like.

Separator

As the separator 53, it is possible to use, for example, a porous polyethylene film, a porous polypropylene film, a non-woven fabric made of synthetic resin, or the like. In the separator 53, a non-aqueous electrolyte which is a liquid electrolyte is impregnated.

Non-Aqueous Electrolyte

The non-aqueous electrolyte includes a liquid solvent, a non-aqueous solvent such as an organic solvent, and an electrolyte salt which is dissolved in the non-aqueous solvent.

It is preferable that the non-aqueous electrolyte includes at least one type of cyclic carbonate such as ethylene carbonate (EC) or propylene carbonate (PC). This is because it is possible to improve cycling characteristics. In particular, it is preferable if ethylene carbonate (EC) or propylene carbonate (PC) are mixed and included as it is possible to further improve cycling characteristics.

It is preferable that, in addition, the non-aqueous electrolyte includes at least one type of a chain carbonate ester such as diethyl carbonate (DEC), dimethyl carbonate (DMC), ethyl methyl carbonate (EMC), or methyl propyl carbonate (MPC). This is because it is possible to further improve the cycling characteristics.

The non-aqueous electrolyte may further include any one type or two or more types of a compound where a portion of or all of the hydrogen groups in the compounds such as butylene carbonate, γ-butyrolactone, or γ-valerolactone is replaced with fluorine groups, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropionitrile, N,N-dimethyl formamide, N-methylpyrrolidinone, N-methyloxazolidinone, N,N-dimethylimidazolidinone, nitromethane, nitroethane, sulfolane, dimethyl sulfoxide, trimethyl phosphate, and the like.

Depending on the assembled electrode, there are cases where reversibility of the electrode reaction is improved due to a compound where a portion of or all of the hydrogen atoms in a substance included in the non-aqueous electrolyte are replaced with fluorine atoms. Accordingly, it is possible to appropriately use these substances.

As the electrolyte salt, it is possible to use a lithium salt. As the lithium salt, for example, there are inorganic lithium salts such as lithium hexafluorophosphate (LiPF₆), lithium tetrafluoroborate (LiBF₄), lithium hexafluoroarsenate monohydrate (LiAsF₆), lithium hexafluoroantimonate (LiSbF₆), lithium perchlorate (LiClO₄), lithium tetrachloroaluminate (LiAlCl₄), perfluoroalkanesulfonate derivatives such as lithium trifluoromethanesulfonate (LiCF₃SO₃), lithium bis(trifluoromethane sulfonyl)imide (LiN(CF₃SO₂)₂), lithium bis(pentafluoroethane sulfonyl)imide (LiN(C₂F₅SO₂)₂), or lithium tris(trifluoromethylsulfonyl)methide (LiC(CF₃SO₂)₃), and it is possible to use the lithium salts as one type by themselves or as a combination of two or more types.

On the other hand, instead of the non-aqueous electrolyte, a solid electrolyte may be used. As the solid electrolyte, it is possible to use any inorganic solid electrolyte or polymer solid electrolyte if it is a material which has conductivity with regard to lithium ions. As the inorganic solid electrolyte, there are lithium nitride (Li₃N), lithium iodide (LiI), and the like. The polymer solid electrolyte is formed from an electrolyte salt and a polymer compound which dissolves the electrolyte salt, and as the polymer compound, it is possible to use an ether polymer such as poly(ethylene oxide) and a material with the same cross-linking, a poly(methacrylate)ester, an acrylate by themselves, with copolymerization in the molecules, or with mixing.

Furthermore, an electrolyte in gel form may be used. As a matrix polymer of an electrolyte in gel form, it is possible to use various polymers if the non-aqueous electrolytes described above are absorbed into a gel form. For example, it is possible to use a fluoropolymer such as a copolymer of hexafluoropropylene and fluoro-polyvinylidene chloride or fluoro-vinylidene chloride, an ether polymer such as polyethylene oxide and a material with the same cross-linking, polyacrylonitrile, or the like. In particular, in terms of oxidation reduction stability, it is preferable to use a fluoropolymer. Ion conductivity is imparted by the electrolyte salt being included.

By a non-aqueous electrolyte battery such as this being used with an upper limit on its charge voltage being 4.25 V or more and 4.80 V or less and a lower limit on its discharge voltage being 2.00 V or more and 3.30 V or less, it is possible to obtain a more remarkable effect in terms of the positive electrode active material of the embodiment.

(1-4) Manufacturing Method of Battery Cell

It is possible to manufacture the battery cell, for example, as described below.

Manufacturing Method of Positive Electrode

For example, the positive electrode active material, the dielectric material, and the binding agent are mixed, a positive electrode binder is prepared, and the positive electrode binder is dispersed in a solvent such as N-methylpyrrolidone and forms a positive electrode binder slurry. Next, after the positive electrode binder slurry is coated on the positive electrode collector 51A and the binding agent is dried, compacting is performed using a rolling press machine or the like, the positive electrode active-material layers 51B are formed, and the positive electrode 51 is prepared.

Manufacturing Method of Negative Electrode

In addition, for example, the negative electrode active material and the binding agent are mixed, a negative electrode binder is prepared, and the negative electrode binder is dispersed in a solvent such as N-methylpyrrolidone and forms a negative electrode binder slurry. Next, after the negative electrode binder slurry is coated on the negative electrode collector 52A and the binding agent is dried, compacting is performed using a rolling press machine or the like, the negative electrode active-material layers 52B are formed and the negative electrode 52 is prepared.

Assembly of Battery Cell

Next, the positive electrode lead 55 is attached to the positive electrode collector 51A by welding or the like and the negative electrode lead 56 is attached to the negative electrode collector 52A by welding or the like. After that, the positive electrode 51 and the negative electrode 52 are rolled via the separator 53, a tip portion of the positive electrode lead 55 is welded to the safety valve mechanism 45, a tip portion of the negative electrode lead 56 is welded to the battery cap 41, and the positive electrode 51 and the negative electrode 52 which have been rolled up are interposed by the pair of insulating plates 42 and 43 and accommodated in an inner portion of the battery can 41.

After the positive electrode 51 and the negative electrode 52 are accommodated in an inner portion of the battery can 41, the electrolyte described above is injected into an inner portion of the battery can 41 and impregnates the separator 53. After this, the battery cap 44, the safety valve mechanism 45, and the positive temperature coefficient element 46 are fixed to the edge portion of the opening of the battery can 41 by caulking via the gasket 47. Due to the above, it is possible to manufacture the battery cell 2a shown in FIG. 5.

(1-5) Configuration of Battery Pack

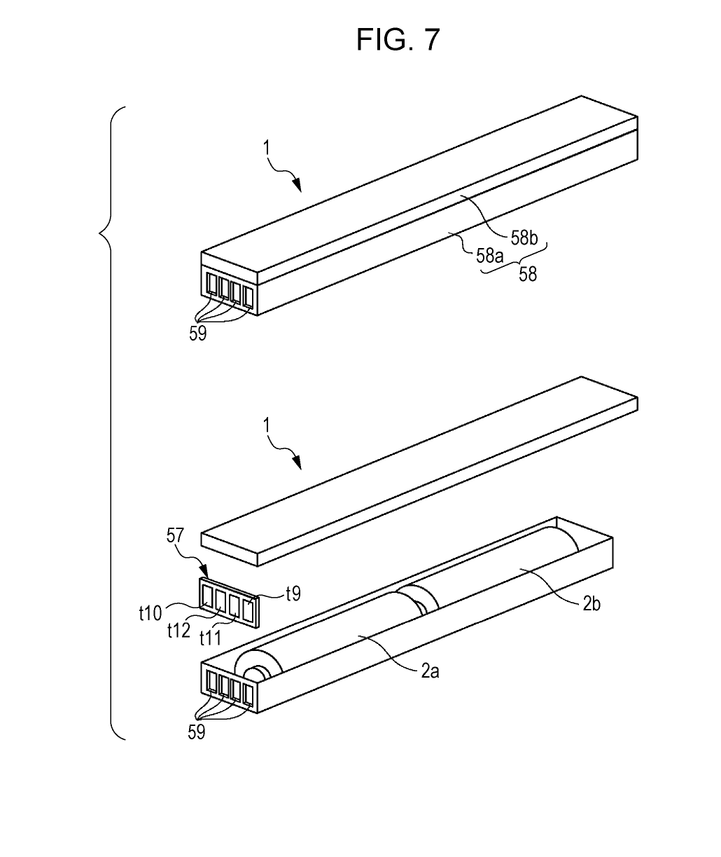

As shown in FIG. 7, the battery cell 2a which has been manufacturer as described above and the battery cell 2b which has the same configuration as the battery cell 2a are connected, for example, in 2 series and connected to a circuit substrate 57. On the circuit substrate 57, the charge control FET 4a, the discharge control FET 4b, the nonvolatile memory 6, the current detection resistor 33a, the protection circuit 34, the fuse 38, the AFE 3a, the CPU 3b, and the like are mounted. In addition, the terminals t9 and t10 which are connected to the positive electrode and negative electrode of the electronic apparatus 10 and the terminals t11 and t12 which perform communication with the electronic apparatus 10 are provided on the circuit substrate 57.

The battery cells 2a and 2b and the circuit substrate 57 are accommodated in an external case 58 which is formed from, for example, a molded resin case. The external case is formed from, for example, a lower case 58a and an upper case 58b. In at least one out of the lower case 58a and the upper case 58b, an opening 59 is provided for exposing the terminals t9, t10, t11, and t12 to the outside. When connected to the electronic apparatus, each terminal which is exposed to the outside via the opening 59 and connection sections of the electronic apparatus are in contact and it is possible to perform charging and discharging and communication of information.

Effects

At the next charging, charging is started with the charge current value I, which is stored in the nonvolatile memory 6 when the current charging ends, as the designated charge current value I. At the next charging, there are many cases where the voltage of the battery cells 2a and 2b is the same as the voltage when the current charging ends or less than the voltage when the current charging ends. As a result, due to the next charging starting at the charge current value I which are stored in the nonvolatile memory 6 when the current charging ends, it is possible to prevent the voltage of the battery cells 2a and 2b from sharply increase and becoming equal to or greater than the prohibited charge voltage in a short period of time.

In addition, by performing control such as this, it is possible to draw out the life of a battery to the maximum extent. In particular, even when the charging and discharging cycle has progressed to where the deterioration of the battery cells is in an unbalanced state, it is possible to perform control so that charging is permanently stopped when the cell voltage reaches the prohibited charge voltage.

### 2. Second Embodiment

In a second embodiment, a charge and discharge system will be described where the charge supply section 12 and the reverse current prevention diodes 13 and 14, which are disposed in the electronic apparatus 10 in the first embodiment, are disposed in the battery pack 1. Here, in the description, only the points which are different from the first embodiment will be described. In addition, the same reference numerals are attached to the same sections to each of the section in the first embodiment.

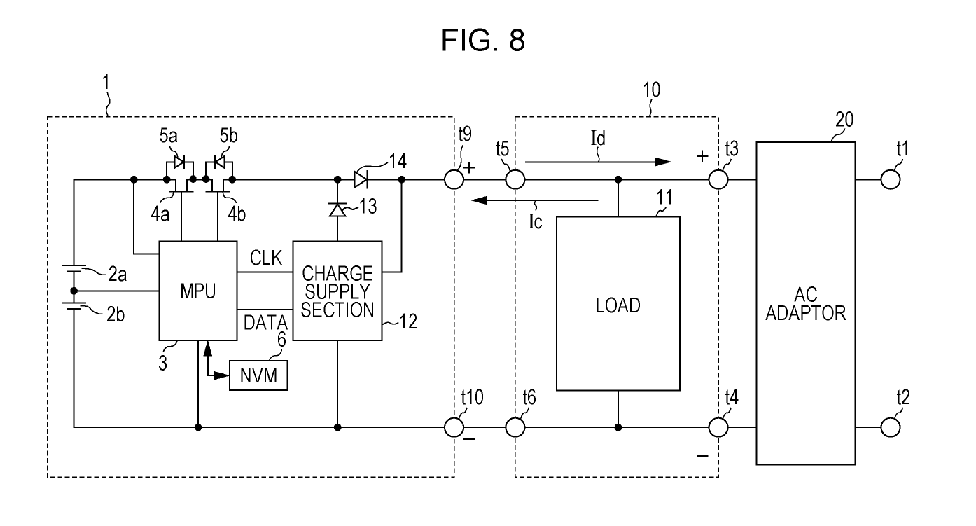

FIG. 8 is a block diagram illustrating a charge system according to the second embodiment. As shown in FIG. 8, the charge system of the second embodiment is configured by the battery pack 1, the electronic apparatus (for example, a portable personal computer) 10, and the AC adapter 20 in the same manner as the first embodiment.

In the charge system of the second embodiment, a DC voltage, which is output from the AC adapter 20 when the commercial power supply and the AC adapter 20 are connected, is supplied with regard to the load 11 of the electronic apparatus 10 and the charge supply section 12 of the battery pack 1. The battery pack 1 of the second embodiment performs a charge operation at the charge current value and the charge voltage value designated by the charge supply section 12 of the battery pack 1 using the MPU 3.

The charge operation of the second embodiment is the same as the first embodiment other than that the charge operation is performed by the MPU 3 of the battery pack 1 or by the control signal being sent from the MPU3 to the charge supply section 12 of the battery pack 1.

Effect

In the second embodiment, it is possible to obtain the same effects as the first embodiment even in a case where the charge supply section 12 is in the battery pack 1.

### 3. Third Embodiment

In a third embodiment, a second charge control method will be described. The second charge current method calculates a maximum permissible charge current value from the voltage of the battery cells 2a and 2b when starting charging and the internal resistance of the battery cells 2a and 2b. Then, in a case where the charge current value I when the previous charging ended which is stored in the nonvolatile memory 6 exceeds the calculated maximum permissible charge current value, charging is started at the calculated maximum permissible charge current value.

Here, it is possible to apply the second charge control method in cases of either the circuit configuration of the first embodiment or the circuit configuration of the second embodiment. Below, only the second charge control method will be described.

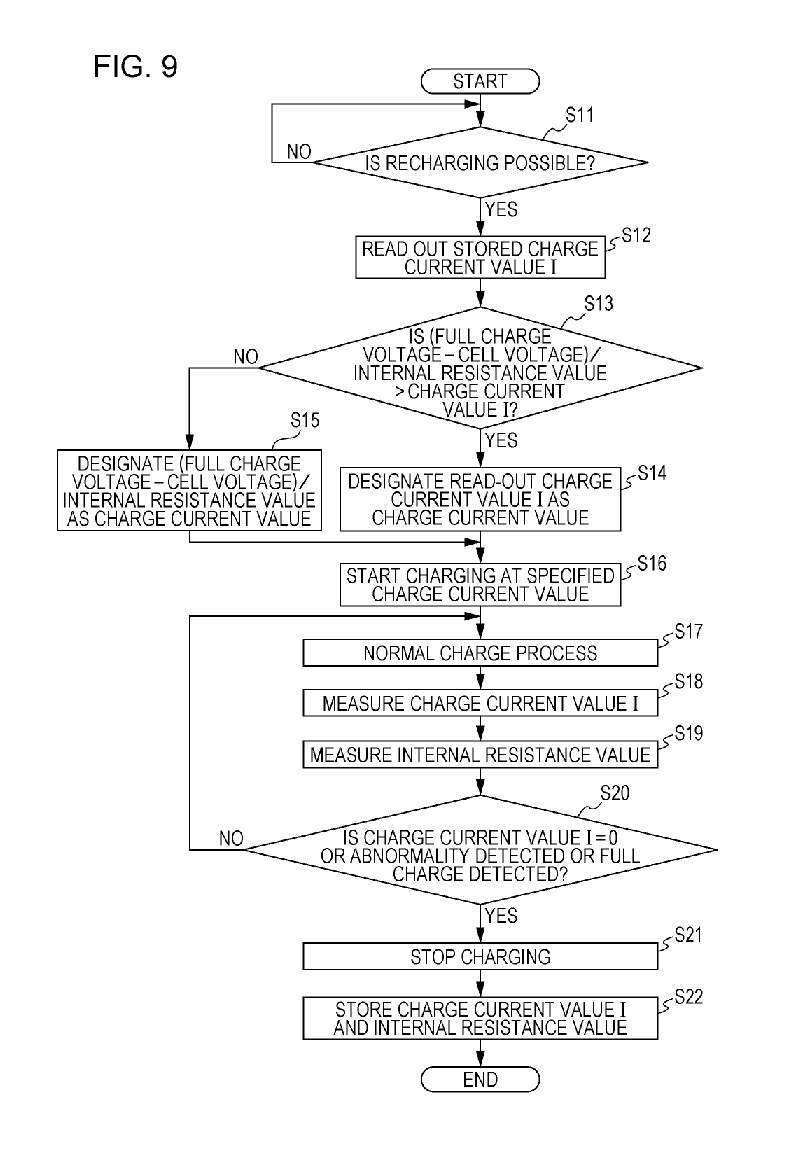

FIG. 9 is a flow chart illustrating a charge operation of the second charge control method. Here, in the case of the circuit configuration of the first embodiment, the process below is performed by the MPU 3 of the battery pack 1 or by the control signal being sent from the MPU 3 to the electronic apparatus 10. In addition, in the case of the circuit configuration of the second embodiment, the process is performed by the MPU 3 of the battery pack 1 or by the control signal being sent from the MPU 3 to the charge supply section 12 of the battery pack 1.

When starting the charge operation, in step S11, it is confirmed whether recharging of the battery cells 2a and 2b is possible. In a case where it is not determined in step S11 that recharging is possible, step S11 is repeated once every constant interval. In a case where it is determined in step S11 that recharging is possible, the process moves to step S12. In step S12, the MPU 3 reads out the charge current value I which is stored in the nonvolatile memory 6. Here, in the second charge control method, the current charge value when the charge operation ends is stored in the nonvolatile memory 6 when the previous charge operation ends in the same manner as the first charge control method. In addition, when shipping the battery pack 1, it is preferable if an appropriate charge current value when starting an initial charge or a charge current value when preparation of charging ends is stored in the nonvolatile memory 6.

Next, in step S13, the maximum permissible charge current value (largest charge current value which is able to be set) is calculated from the full charge voltage, the cell voltage, and the internal resistance value of the battery cells 2a and 2b using the equation below.

maximum permissible charge current value=(full charge voltage-cell voltage)/internal resistance value equation (1)

Here, the equation takes into consideration the state of the battery cells when starting charging and calculates the charge current value where the voltage of the battery cells only rises to the full charge voltage even at its maximum. The maximum permissible charge current value calculated in step S13 and the charge current value I when the previous charge operation ends which is stored in the nonvolatile memory 6 are compared. The comparison is performed by, for example, the calculation section 37. Then, in a case where it is determined that the charge current value I when the previous charge operation ends which is stored in the nonvolatile memory 6 is less than the calculated maximum permissible charge current value, the process moves to step S14. In this case, even if the charging starts at the stored charge current value I, the full charge voltage is not reached. As a result, in step S14, the charge current value I when the previous charge operation ends which is stored in the nonvolatile memory 6 is designated as the charge current value when the current charging starts.

On the other hand, in a case where it is not determined in step S13 that the charge current value I when the previous charge operation ends which is stored in the nonvolatile memory 6 is less than the calculated maximum permissible charge current value, the process moves to step S15. In this case, there is a concern that the cell voltage will suddenly reach the full charge voltage if the charging starts at the stored charge current value I. As a result, in step S15, the maximum permissible charge current value which is determined by the equation {(full charge voltage-cell voltage)/internal resistance value} is designated as the charge current value when the current charging starts.

Here, in step S13, in a case where the maximum permissible charge current value described above is calculated using the voltage and the internal resistance value of the entire assembled battery 2, there is a high possibility that the battery cell with a high cell voltage after the charging starts exceeds the full charge voltage in a case where there is variation in the cell voltage. As a result, it is preferable to perform a comparison with regard to the battery cell where the cell voltage is the largest out of the battery cells 2a and 2b which configure the assembled battery 2. In addition, in a case where there is variation in the deterioration of each of the battery cells, the battery cell where the internal resistance value is the largest has a smaller maximum permissible charge current value even in a case where the cell voltages are the same. As a result, the maximum permissible charge current value is calculated with regard to each of the battery cells 2a and 2b which configure the assembled battery 2, and in regard to the battery cell with the smallest maximum permissible charge current value, it is preferable if a comparison is performed with the read-out charge current value I which is read out with regard to the battery cell with the smallest maximum permissible charge current value. Here, the cell voltage used in the calculation in step S13 is before the start of charging and thus the open circuit voltage OCV of the battery cells 2a and 2b is used.

The MPU 3 sends the charge current value designated in step S14 and step S15 (the charge current value I or the charge current value obtained by (full charge voltage-cell voltage)/internal resistance value) to the charge supply section 12. Next, in step S16, in a case where the charge control FET 4a is OFF, the charge control FET 4a is turned ON and the charging of the battery cells 2a and 2b starts at the designated charge current value. The battery cells 2a and 2b are charged by the charge supply section 12 generating the designation value of the charge current and the charge voltage.

From the start of the charging of the battery cells 2a and 2b in step S16 onward, the charge operation is the same as the first embodiment. When the charge operation starts in step S16, a normal charge process is performed in step S17 such as charging with a constant current and a constant voltage with the predetermined full charge voltage as the upper limit of the voltage, performing excess charge protection and excess discharge protection described above, and the like.

Next, in step S18, the charge current value I is measured once every predetermined constant interval. In addition, in step S19, the internal resistance value of the battery cells 2a and 2b is measured. It is preferable that the internal resistance value is measured so that the internal resistance value of all of the battery cells is measured in order that either of the battery cells is able to be adopted when starting the next charge operation.

Then, in a case where it is determined in step S19 that the charge current value I is equal to zero, an abnormality is detected, or there is the full charge state, the process moves to step S20, and the charging is stopped by the discharging control FET 4b being turned OFF. In a case where it is not determined in step S19 that the charge current value I is equal to zero, an abnormality is detected, or there is the full charge state, the process returns to step S17 and the normal charge process is continued. In a case where the charging is stopped in step S20, the process moves to step S21 and the charge current value I which was measured last is stored in the nonvolatile memory 6. According to this, the charging process ends.

Effects

In the embodiment, charge control is performed so that it is determined whether the charge current value when the charge current ends which is stored in the nonvolatile memory 6 is appropriate as the charge current value when restarting the charge operation. As a result, it is determined whether the charge current value is appropriate with regard to the state of the battery cells at the time when charging starts, and in a case where the charge current value is not appropriate, it is possible to further suppress the voltage of the battery cells rising to the prohibited charge voltage since an appropriate charge current value is designated and safety is increased.

### 4. Fourth Embodiment

In a fourth embodiment, a third charge control method will be described. In the third charge control method, rapid charging is possible by making the charge current value able to be varied according to the cell voltage during the normal charge control in the first charge control method and the second charge control method.

Here, it is possible to apply the third charge control method in cases of either the circuit configuration of the first embodiment or the circuit configuration of the second embodiment. Below, only the third charge control method will be described. The third charge control method is a charge control method of the normal charge control method in step S5 of the first charge control method and the normal charge control method in step S17 of the second charge control method.

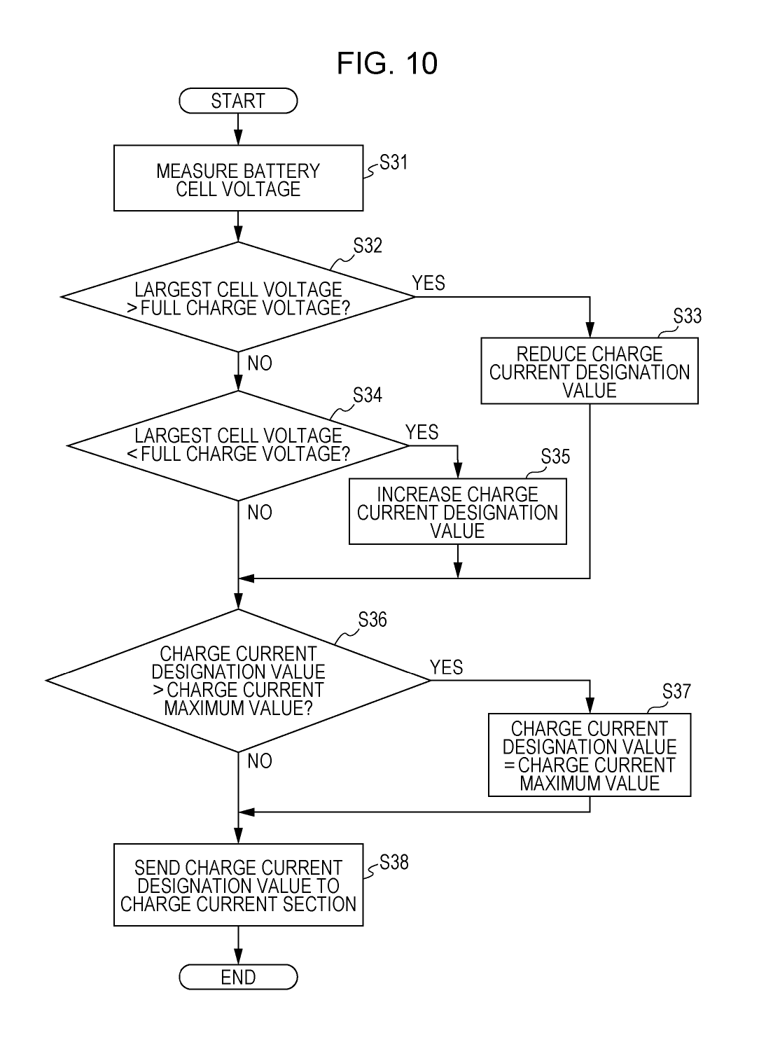

FIG. 10 is a flow chart illustrating a charge operation of the third charge control method. During the normal charge operation, the voltage value of each battery cell (the battery cells 2a and 2b) are measured in step S31. The voltage value of each of the battery cells is a total of the internal resistance, the voltage which is determined as the product of the currents, and the electromotive force. In a case of a battery cell where the extent of deterioration has progressed, since the internal resistance has increased, the voltage value of the battery cell has also become larger. In step S32, the cell voltage value which is the largest out of the measured voltage values (referred to below as the largest cell voltage) is compared to the full charge voltage value (for example, 4.2 V). The full charge voltage value (refer to below as the full charge voltage) is stored in the nonvolatile memory 6 in combination with the configuration of the battery pack.

When it is determined in step S32 that the largest cell voltage is larger than the full charge voltage, in step S33, the charge current designation value is changed to be designated as a charge current where the previous charge current is reduced by a predetermined amount, for example, 10mA. The amount of change in the charge current is set so that there is an appropriate change in the cell voltage. The amount of change in the charge current is not fixed and may vary according to the voltage difference. Each of the cell voltages is reduced by the charge currents being reduced. According to this, it is possible to prevent the cell voltage being greater than or equal to the prohibited charge voltage. After the charge current designation value is reduced in step S33, the process moves to step S36.

On the other hand, in a case where it is determined in step S32 that the largest cell voltage is not larger than the full charge voltage, in step S34, it is determined whether or not the largest cell voltage is smaller than the full charge voltage. When it is determined that the largest cell voltage is smaller than the full charge voltage, in step S35, the charge current designation value is changed to be designated as a charge current where there is an increase by a predetermined amount, for example, 10 mA, with regard to the previous value. Each of the cell voltages increases due to the increase in the charge current. Accordingly, in a case where charging is performed with the charge current value I which is stored when the previous charge operation ends being designated as the initial value when starting charging, it is possible to perform charging at the larger charge current value in a case where there is surplus in the cell voltage and it is possible to reduce the charge time until full charge. In step S35, after the charge current designation value is increased, the process moves to step S36.

In a case where it is not determined in step S34 described above that the largest cell voltage is smaller than the full charge voltage, that is, in a case where the largest cell voltage is equal to the full charge voltage, the charge current designation value is not changed, and in step S36, it is determined whether or not the charge current designated by the charge current designation value is larger than a charge current maximum value. The charge current maximum value is a value set in advance and is set to a value where there is no damage to each section in the battery pack 1. After the control in step S33 (reduction of the charge current designation value) or step S35 (increase of the charge current designation value), the determination process of step S36 is performed in both cases.

In a case where it is determined in step S36 that the charge current designated by the charge current designation value is larger than the charge current maximum value, in step S37, the charge current designation value is set so as to be designated as the charge current maximum value. In a case where it is not determined in step S36 that the charge current designated by the charge current designation value is larger than the charge current maximum value, that is, in a case where the charge current designation value is equal to or less than the charge current maximum value, the charge current designation value is not changed. Then, in step S38, the charge current designation value is sent from the MPU 3 to the charge supply section 12.

Here, although omitted in FIG. 7, the charge voltage designation value, which designates the charge voltage maximum value (for example, a predetermined voltage of 4.2 V×2=8.4 V or more) where charging of the battery pack 1 is possible which is read out from the nonvolatile memory 6, is also sent from the MPU 3 to the charge supply section 12. Since the charge voltage designation value is a fixed value, it is sufficient if the charge voltage designation value is sent once before the start of charging in relation to the same battery pack. On the other hand, the charge current designation value is sent every time that the charge current designation value calculation process described above is performed.

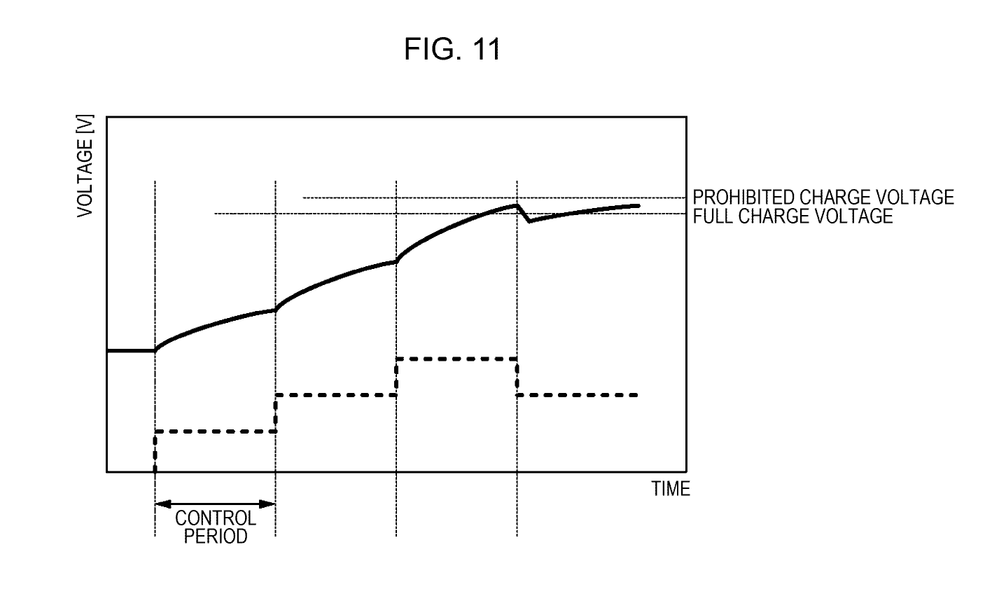

FIG. 11 is a graph illustrating the voltage value (solid line) and the current value (dotted line) of the battery cell in a case where the charge control method of FIG. 10 is used. In a constant control period, in a case where a predetermined charge current value is designated and charging is performed, a larger charge current value is re-designated and charging is continued in a case where the cell voltage is smaller than the full charge voltage. According to this, it is possible to perform charging by specifying a larger charge current value within a range where the cell voltage of the battery cell does not reach the prohibited charge voltage. In addition, in a case where the cell voltage is larger than the full charge voltage, a smaller charge current value is designated and charging is continued. According to this, it is possible for the charging of the battery cell to be performed for longer within a range where the prohibited charge voltage is not reached.

Effects

In the fourth embodiment, it is possible to set an appropriate charge current value by comparing the cell voltage of the battery cell and the full charge voltage even during normal charging. Accordingly, in a case where the cell voltage is lower, a larger charge current value is designated and rapid charging is possible. In addition, in a case where the cell voltage is close to the full charge voltage or in a case where the extent of deterioration is large and it is easy for the voltage to increase sharply, it is possible to control the cell voltage so that the prohibited charge value is not reached by specifying a smaller charge current value. As a result, a higher degree of safety is provided and it is possible to draw out the life of the battery cell to the maximum extent.

Below, the disclosure will be described in detail using an applied example. Here, the disclosure is not limited only to the applied example.

### APPLIED EXAMPLE 1

Manufacturing of Positive Electrode

As the positive electrode active material, 96% by weight of lithium cobalt oxide (LiCoO₂), 1% by weight of Ketjen black as the dielectric material, 3% by weight of polyvinylidene fluoride in powder form as the binding agent are uniformly mixed and dispersed in N-methyl-2-pyrrolidine, and a positive electrode binder in slurry form is prepared. The positive electrode binder is uniformly coated on both surfaces of aluminum (Al) foil which will become the positive electrode collector and is decompressed and dried for 24 hours at 100° C.

Next, the positive electrode binder is made into a positive electrode sheet by pressure molding using a rolling press machine, the positive electrode sheet is cut into a strip shape, and the positive electrode is formed. Furthermore, the positive electrode terminal which is formed from an aluminum (Al) ribbon is welded to a portion where the positive electrode active material is not formed on the positive electrode collector.

Manufacturing of Negative Electrode

As the negative electrode active material, 94% by weight of graphite and 6% by weight of polyvinylidene fluoride in powder form as the binding agent are uniformly mixed and dispersed in N-methyl-2-pyrrolidine, and a negative electrode binder in slurry form is prepared. Next, the negative electrode binder is uniformly coated on both surfaces of copper (Cu) foil which will become the negative electrode collector and the negative electrode active-material layer is formed by negative electrode binder being decompressed and dried for 24 hours at 120° C.

Next, the negative electrode active-material layer is made into a negative electrode sheet by pressure molding using a rolling press machine, the negative electrode sheet is cut into a strip shape, and the negative electrode is formed. Furthermore, the negative electrode terminal which is formed from a nickel (Ni) ribbon is welded to a portion where the negative electrode active material is not formed on the negative electrode collector.

Preparation of Non-Aqueous Electrolyte

The non-aqueous electrolyte is prepared by lithium hexafluorophosphate (LiPF₆) which is the electrolyte salt being added to and mixed with a non-aqueous solvent, where ethylene carbonate (EC) and dimethyl carbonate (DMC) are mixed at a mass ratio of one to one, so as to be 1 mol/l.

Assemble of Battery Cell

The positive electrode and negative electrode with strip shapes which are manufactured as above are laminated via a separator which is formed from micro-porous polyolefin film with a thickness of 20 μm, a plurality are rolled up, and a rolled electrode with a spiral shape is manufactured. The rolled electrode is accommodated in a battery can formed from iron which has been plated with nickel in a state where an insulation plate is arranged on both the upper and lower rolled surfaces of the rolled electrode. Next, a negative terminal formed from nickel which is connected to the negative electrode collector is welded to the bottom portion of the battery can. After that, a center pin is inserted into a center portion of the rolled electrode. In addition, a positive electrode terminal formed from aluminum which is connected to the positive electrode collector is welded to a protruding portion of a safety valve where electrical conduction with the battery cap is secured.

Finally, after a non-aqueous electrolyte liquid is inserted into the battery can where the rolled electrode described above has been embedded, and by caulking the battery can and the battery cap using an insulation sealing gasket, the battery cap along with the safety valve and the PTC element are fixed. According to this, a cylindrical battery with an outer circumference of 18 mm and a height of 65 mm is manufactured so that the tight sealing in the battery cell is maintained.

Next, the battery pack shown in FIG. 3 is manufactured using three battery cells which are lithium ion secondary batteries which are obtained as described above. Then, the manufactured battery pack is charged until near the full charge voltage. At this time, there is a simulation of the voltage of each cell being deteriorated and there being a difference in capacitance, and a difference in voltage of 4.00 V, 4.10 V, and 4.20 V is set for each of the battery cells.

The battery pack manufactured in this manner is charged using the control method in the related art and the control method and a comparison is performed.

(a) Charge Control Method in Related Art

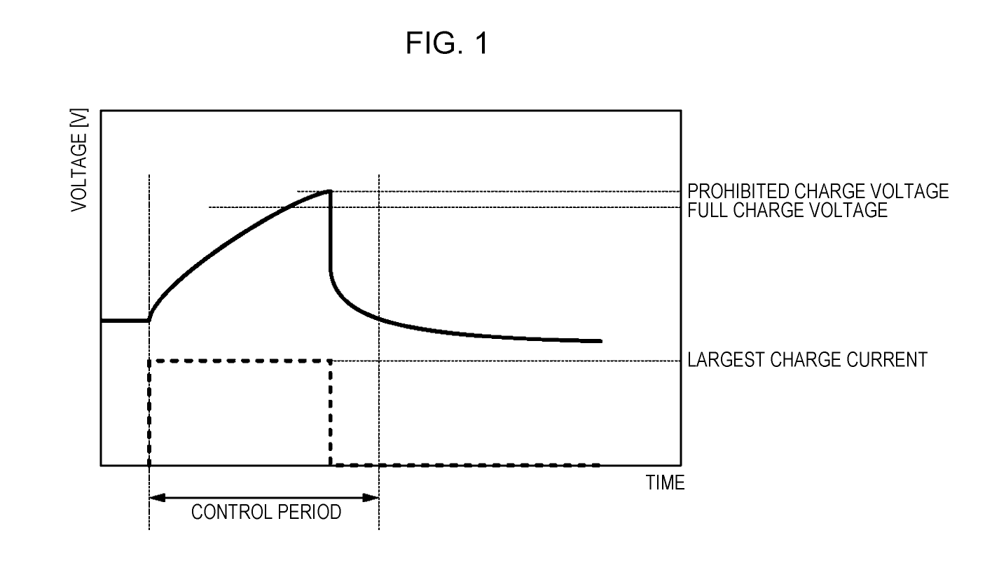

In the charge control method in the related art, since the cell voltage exceeds the prohibited charge voltage immediately after the charging started at the largest charge current value, the largest voltage cell and the full charge voltage are compared, and the prohibited charge current is detected and charging is stopped before the control operates to change the charge current. The behavior of the voltage and the current of the battery pack which uses the charge control method in the related art is as in FIG. 1.

(b) Charge Control Method of Disclosure

In the charge control method, charging is started at the charge current value of the previous charging to near the full charge. As a result, it is possible to confirm that the cell voltage does not exceed the prohibited charge voltage immediately after charging starts and charging continues. The behavior of the voltage and the current of the battery pack which uses the charge control method is as in FIG. 11.

As a result, by using the charge control method, it is understood that it is difficult for the voltage of the battery cell to be equal to or more than the prohibited charge current.

Above, the embodiments have been described in detail, but the disclosure is not limited to the embodiments described above and various modifications are possible based on the technical concept.

For example, the numerical values used in the embodiments described above are only examples and different numerical values may be used when necessary. Since the determination standard of the state of the battery differs according to the type of the secondary battery, an appropriate reference value is set according to the secondary battery used.

In addition, an example where the battery cells 2a and 2b are cylindrical batteries is used and described. However, a battery or a square-shaped battery encased in a laminate film, a battery with a coin shape, a button shape, or the like may be used as the battery cells 2a and 2b.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A charge control method of secondary batteries comprising:
measuring a charge current value when charging ends with regard to an assembled battery where a plurality of secondary batteries are connected in series, in parallel, or in series-parallel;
storing the charge current value; and
performing charging of the secondary batteries at the stored charge current value when starting the next charging with regard to the secondary batteries.

2. The charge control method of secondary batteries according to claim 1, further comprising:
measuring an internal resistance value of the secondary batteries when charging ends with regard to the secondary batteries;
calculating a maximum permissible charge current value from equation (1) using the internal resistance value when charging ends with regard to the secondary batteries and comparing the maximum permissible charge current value and the stored charge current value; and
performing charging at the maximum permissible charge current value when starting the next charging with regard to the secondary batteries in a case where the stored charge current value is equal to or larger than the maximum permissible charge current value,
wherein equation (1) is maximum permissible charge current value=(full charge voltage-cell voltage)/internal resistance value.

3. The charge control method of secondary batteries according to claim 2, further comprising:
measuring a battery voltage and the charge current value of each of the plurality of secondary batteries during charging with regard to the secondary batteries;
comparing the largest cell voltage, which is the largest cell voltage out of the battery voltages of the plurality of secondary batteries, and a full charge voltage which is stored in advance; and
reducing the charge current value in a case where the largest cell voltage exceeds the full charge voltage.

4. The charge control method of secondary batteries according to claim 3, further comprising:
measuring the battery voltage and the charge current value of each of the plurality of secondary batteries during charging with regard to the secondary batteries;
comparing the largest cell voltage, which is the largest out of the battery voltages of the plurality of secondary batteries, and the full charge voltage which is stored in advance; and
increasing the charge current value in a case where the largest cell voltage is less than the full charge voltage.

5. The charge control method of secondary batteries according to claim 4, further comprising:
measuring the battery voltage and the charge current value of each of the plurality of secondary batteries during charging with regard to the secondary batteries;
comparing the largest cell voltage, which is the largest out of the battery voltages of the plurality of secondary batteries, and the full charge voltage which is stored in advance;
comparing the charge current value and a charge current maximum value which is set in advance in a case where the largest cell voltage and the full charge voltage are equal; and
setting the charge current voltage to be equal to the charge current maximum value in a case where the charge current value is larger than the charge current maximum value which is set in advance.

6. A battery pack, which supplies a charge current designated by a charge current value to a secondary battery, comprising:
an assembled battery where a plurality of secondary batteries are connected in series, in parallel, or in series-parallel;
a switch element which controls charging and discharging of the secondary batteries;
a measurement section which measures a battery voltage of each of the plurality of secondary batteries and measures a charge current value of the secondary batteries;
a calculation section which detects the largest cell voltage which is the largest battery voltage out of the measured battery voltages of the plurality of secondary batteries and sets the charge current value which is stored in a storage unit as the charge current when starting charging when starting the next charging with regard to the secondary batteries;
a switch element control section which controls the switch element based on the measured battery voltage of the plurality of secondary batteries;
a storage unit which stores a full charge voltage and the charge current value when charging ends; and
a communication section which is able to perform communication with a connected electronic apparatus and send the charge voltage value which is set by the calculation section, where the charge current which is designated by the charge current value is supplied to the secondary battery.

7. The battery pack according to claim 6, further comprising:
an internal resistance measurement section which measures an internal resistance value of each of the secondary batteries,
wherein the internal resistance measurement section measures the internal resistance values of the secondary batteries when charging ends with regard to the secondary batteries,
the calculation section calculates a maximum permissible charge current value from equation (1) using the internal resistance value when starting charging with regard to the secondary batteries, compares the maximum permissible charge current value and the stored charge current value, and sets the maximum permissible charge current value as the charge current value when starting charging, and
equation (1) is maximum permissible charge current value=(full charge voltage-cell voltage)/internal resistance value.

8. The battery pack according to claim 7,
wherein the calculation section measures the battery voltage and the charge current value of each of the plurality of secondary batteries during charging with regard to the secondary batteries, detects the largest cell voltage which is the largest cell voltage out of the battery voltages of the plurality of secondary batteries, compares the detected largest cell voltage and the full charge voltage, sets the charge current value so that the charge current is reduced in a case where the largest cell voltage exceeds the full charge voltage, sets the charge current value so that the charge current is increased in a case where the largest cell voltage is less than the full charge voltage, performs control to change a charge current designation value periodically during charging, and sends the charge current value via the communication section.

9. A battery pack comprising:
an assembled battery where a plurality of secondary batteries are connected in series, in parallel, or in series-parallel;
a switch element which controls charging and discharging of the secondary batteries;
a measurement section which measures a battery voltage of each of the plurality of secondary batteries and measures a charge current value of the secondary batteries;
a calculation section which detects a largest cell voltage which is the largest battery voltage out of the measured battery voltages of the plurality of secondary batteries and sets the charge current value which is stored in a storage unit as the charge current when starting charging when starting the next charging with regard to the secondary batteries;
a switch element control section which controls the switch element based on the measured battery voltage of the plurality of secondary batteries;
a storage unit which stores a full charge voltage and the charge current value when charging ends; and
a charge supply section which has a variable current source and a variable voltage source where it is possible for a charge current which is designated by the charge current value set by the calculation section and a predetermined charge voltage to be generated and supplied to the secondary batteries.

10. The battery pack of the secondary batteries according to claim 9, further comprising:
an internal resistance measurement section which measures an internal resistance value of each of the secondary batteries,
wherein the internal resistance measurement section measures the internal resistance values of the secondary batteries when charging ends with regard to the secondary batteries,
the calculation section calculates a maximum permissible charge current value from equation (1) using the internal resistance value when starting charging with regard to the secondary batteries, compares the maximum permissible charge current value and the stored charge current value, and sets the maximum permissible charge current value as the charge current value when starting charging,
the charge supply section supplies the charge current, which is designated by the maximum permissible charge current value set by the calculation section, with regard to the secondary batteries, and
equation (1) is maximum permissible charge current value=(full charge voltage-cell voltage)/internal resistance value.

11. The battery pack of the secondary batteries according to claim 10,
wherein the calculation section measures the battery voltage and the charge current value of each of the plurality of secondary batteries during charging with regard to the secondary batteries, detects the largest cell voltage which is the largest cell voltage out of the battery voltages of the plurality of secondary batteries, compares the detected largest cell voltage and the full charge voltage, sets the charge current value so that the charge current is reduced in a case where the largest cell voltage exceeds the full charge voltage, sets the charge current value so that the charge current is increased in a case where the largest cell voltage is less than the full charge voltage, and performs control to change a charge current designation value periodically during charging, and
the charge supply section charges the secondary batteries based on the charge current value set by the calculation section.
